(19) United States
(12) Patent Application Publication
(10) Pub. No.: US 2011/0187334 A1
(43) Pub. Date: Aug. 4, 2011

(54) POWER SUPPLY CIRCUIT AND ELECTRONIC DEVICE

(76) Inventor: Ryuji YAMAMOTO, Yao-shi, Osaka (JP)

(21) Appl. No.: 13/017,674

(22) Filed: Jan. 31, 2011

(30) Foreign Application Priority Data
Feb. 1, 2010 (JP) 2010-19884

(51) Int. Cl. G05F 1/10

(52) U.S. Cl. 323/265

(57) ABSTRACT

A power supply circuit 10 includes a first error amplifier that compares a predetermined reference voltage and an output voltage of a feedback voltage generation circuit and amplifies the obtained error to input the amplified error to the feedback voltage generation circuit; and a gain adjustment path which is disposed in parallel with the first error amplifier and adjusts a gain of output of the first error amplifier in a high frequency range.

### CROSS-REFERENCE TO RELATED APPLICATION(S)

This application claims priority to Japanese Patent Application No. 2010-19884, filed on Feb. 1, 2010, which is incorporated herein by reference in its entirety.

### BACKGROUND

1. Technical Field

The present invention relates to a power supply circuit and an electronic device, more particularly to a power supply circuit for supplying an output of a switching regulator to a load and to an electronic device including the power supply circuit.

2. Related Art

Batteries are used as a power supply for a mobile electronic device such as a mobile phone, a personal handy-phone system (PHS), a personal digital assistant (PDA), or a personal computer (PC). So-called switching regulators may be used to generate a predetermined voltage to be supplied to each component of any of these electronic devices.

As an example configuration of a switching regulator, JP 2005-174264A, for example, describes a chopper-type boosting switching regulator as a circuit which boosts a lowered power supply voltage to a predetermined output voltage in order to drive a mobile device even when a power supply voltage from batteries mounted on the mobile device with a communication function is lowered. JP 2005-17426A further discloses a configuration which includes an error amplifier that compares an output voltage of the switching regulator with a reference voltage, and outputs an error signal based on the obtained difference; a PWM circuit that sets a duty ratio of a PWM signal based on the error signal from the error amplifier; a switching transistor that is turned ON when the PWM signal is high; a boost coil whose electric current is controlled based on the switching control of the switching transistor; and a capacitor that stores a voltage from the boost coil and outputs an output voltage.

Generally, switching regulators include an error amplifier that compares a reference voltage and an output of a feedback voltage generation circuit for generating a feedback voltage, and amplifies and outputs the obtained error to supply the amplified error back to the feedback voltage generation circuit. It should be noted that the error amplifier used in a switching regulator is often designed with sufficiently large phase and gain margins in order to avoid oscillation. However, a switching regulator which is designed to include such an error amplifier with large phase and gain margins has a problem in that gain characteristics in a high frequency range are comparatively degraded.

### SUMMARY

A power supply circuit according to the present invention is characterized by including a first error amplifier that compares a predetermined reference voltage and an output voltage of a feedback voltage generation circuit, and amplifies an obtained error to input the amplified error to the feedback voltage generation circuit; and a gain adjustment path that is disposed in parallel with the first error amplifier and adjusts a gain of an output of the first error amplifier in a high frequency range.

An electronic device according to the present invention is characterized by including the above-described power supply circuit.

### BRIEF DESCRIPTION OF THE DRAWINGS

Preferred embodiments of the present invention will be described in detail based on the following drawings, wherein:

FIG. 1 shows a power supply circuit according to an embodiment of the present invention;

FIG. 2 shows a simulation result of a comparison between a power supply circuit according to an embodiment of the present invention and a conventional circuit (equivalent to the power supply circuit without a gain adjustment circuit) regarding gain and phase characteristics from V₂ to V₃;

FIG. 3A shows a simulation result of transient response characteristics of a power supply circuit according to an embodiment of the present invention; and

FIG. 3B shows a simulation result of transient response characteristics of a conventional circuit (equivalent to the power supply circuit without a gain adjustment circuit) to be compared with the transient response characteristics of a power supply circuit according to an embodiment of the present invention.

### DETAILED DESCRIPTION

Embodiments according to the present invention are described in detail below with reference to the accompanying drawings. Throughout the drawings, the same reference numerals are assigned to similar elements to avoid repeating explanations. In the descriptions below, previously cited reference numerals are indicated where appropriate.

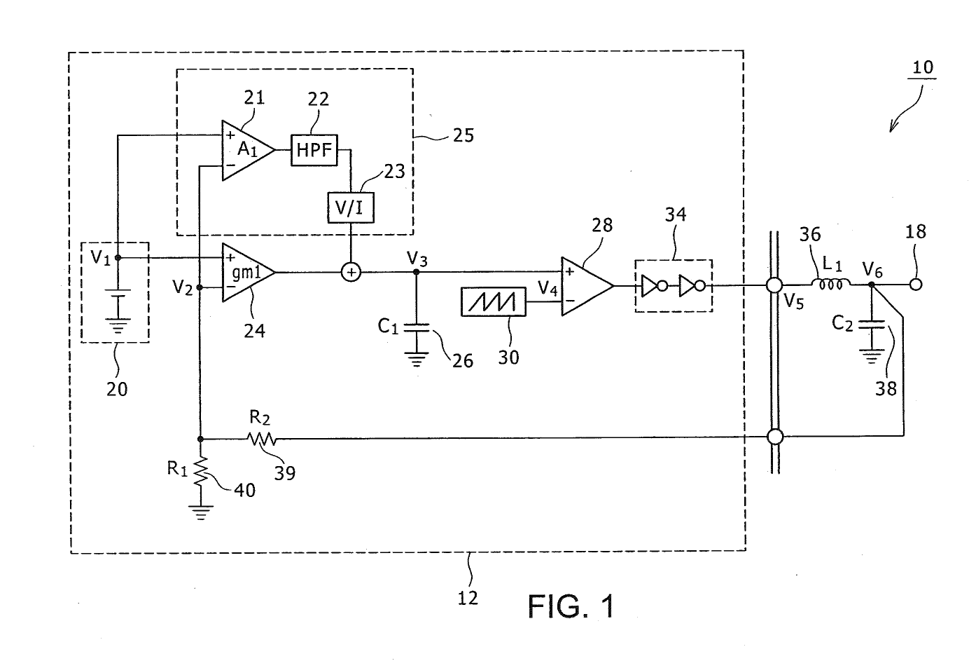

FIG. 1 shows a power supply circuit 10. The power supply circuit 10 is configured to include a switching regulator unit 12 and is connected to a load via an inductor 36, a capacitor 38, and an overall output terminal 18. The description below is made on the assumption that the power supply circuit 10 is mounted on a mobile phone.

The switching regulator unit 12 is configured to include a first reference voltage circuit 20, an error amplifier 24, a gain adjustment circuit 25, a phase compensation capacitor 26, a PWM comparator 28, a PWM reference voltage circuit 30 for the PWM comparator 28, an output-stage circuit 34, a resistor element (R₁) 40, and a resistor element (R₂) 39. It should be noted that a group including the PWM comparator 28, the PWM reference voltage circuit 30, the output-stage circuit 34, the resistor element (R₁) 40, the resistor element (R₂) 39, the inductor 36, and the capacitor 38 is called a “feedback voltage generation circuit.”

The first reference voltage circuit 20 is a reference voltage source which generates a reference voltage V₁ in the switching regulator unit 12. The switching regulator unit 12 uses a feedback technique such that even when an electric current fluctuation or the like occurs in a load, the switching regulator unit 12 can function to output a constant voltage.

The error amplifier 24 is a gm amplifier that amplifies a deviation between a voltage V₁ which is input to a first terminal thereof from the first reference voltage circuit 20 and a feedback voltage V₂ which is input to a second terminal thereof and then outputs the amplified deviation as an electric current deviation. The error amplifier 24 is configured to include an amplifier with sufficiently large gain and phase margins. Further, the gain adjustment circuit 25 described in detail below is a circuit which is arranged in parallel with the error amplifier 24. The phase compensation capacitor 26 is charged by an electric current in which an output electric current of the error amplifier 24 and an output electric current of the gain adjustment circuit 25 are added. Electric potential V₃ of the phase compensation capacitor 26 is supplied to a first terminal of the PWM comparator 28.

FIG. 1 shows that, in the vicinity of the error amplifier 24, the resistor element 39 (R₂) and the resistor element 40 (R₁) are connected in series in this order from the overall output terminal 18 towards the ground electric potential side. In other words, a first terminal of the resistor element 39 (R₂) is connected to the overall output terminal 18 while a second terminal of the resistor terminal 39 (R₂) is connected to a first terminal of the resistor element 40 (R₁). A second terminal of the resistor element 40 (R₁) is connected to the ground electric potential side. Further, the contact point where the second terminal of the resistor element 39 (R₂) and the first terminal of the resistor element 40 (R₁) are connected is connected to the second terminal of the error amplifier 24 and the second terminal of the gain adjustment amplifier 21 of the gain adjustment circuit 25.

The PWM comparator 28 is a differential amplifier that has a function to compare and amplify a voltage deviation between a voltage V₃ which is input to a first terminal thereof and a PWM reference voltage V₄ which is input to a second terminal thereof to output the amplified voltage deviation to the output-stage circuit 34. It should be noted that, as shown above, the voltage V₃ is a voltage which is generated when the error between the voltage V₂ which is a feedback voltage input into the second terminal of the error amplifier 24 and the first reference voltage V₁ which is input to the first terminal of the error amplifier 24 is output as an electric current to charge the phase compensation capacitor 26.

The PWM reference voltage circuit 30 is a reference voltage source for outputting a PWM reference voltage V₄. As the PWM reference voltage circuit 30, there may be used an oscillation waveform generating circuit which generates and outputs a signal of a saw-tooth waveform or a triangular waveform having a predetermined frequency.

The output-stage circuit 34 is a buffer circuit which outputs an output signal of the PWM comparator 28 in low impedance.

The inductor 36 has a function to transform a pulse signal which is an output signal of the switching regulator unit 12 to electromagnetic energy. More specifically, the inductor 36 stores energy when a pulse signal is ON while the inductor 36 discharges the stored energy to the overall output terminal 18 when a pulse signal is OFF. As the inductor 36, a suitable coil may be used.

The capacitor 38 is a smoothing capacitor which is disposed between the overall output terminal 18 and the ground potential to suppress fluctuation of the output voltage V₆ of the overall output terminal 18.

The gain adjustment circuit 25 is a circuit that amplifies a deviation between the voltage V₁ which is input to a first terminal thereof from the first reference voltage circuit 20 and the feedback voltage V₂ which is input to a second terminal thereof and outputs the amplified deviation as an electric current deviation. The gain adjustment circuit 25 is arranged in parallel with the error amplifier 24 so as to adjust, among the output from the error amplifier 24, a gain in a high frequency range. The gain adjustment circuit 25 is configured to include a gain adjustment amplifier 21, a high-pass filter (HPF) 22, and a voltage-current (V/I) conversion circuit 23.

The gain adjustment amplifier 21 is an operational amplifier that amplifies a deviation between the voltage V₁ which is input to a first terminal thereof from the fist reference voltage circuit 20 and the feedback voltage V₂ which is input to a second terminal thereof, and outputs the amplified deviation as a voltage deviation. The gain adjustment amplifier 21 is configured to include an operational amplifier which has gain characteristics higher than those of the error amplifier 24 in a high frequency range.

The high-pass filter (HPF) 22 is a filter circuit which blocks, among the outputs of the gain adjustment amplifier 21, an output in a low frequency range and passes an output only in a high frequency range, and then supplies the output to the voltage-current (V/I) conversion circuit 23.

The voltage-current (V/I) conversion circuit 23 is a voltage-current conversion circuit which converts the output voltage of the high-pass filter (HPF) 22 to electric current. The output terminal of the voltage-current (V/I) conversion circuit 23 is connected to the output terminal of the error amplifier 24 such that the output current of the voltage-current (V/I) conversion circuit 23 is added to the output of the error amplifier 24.

Operations of the power supply circuit 10 having the above configuration are described below with reference to FIGS. 1 to 3. In the power supply. circuit 10, a voltage V₁ is input from the first reference voltage circuit 20 to the first terminal of the error amplifier 24 and the first terminal of the gain adjustment amplifier 21 of the gain adjustment circuit 25 which is disposed in parallel with the error amplifier 24. Further, a feedback voltage V₂ from the feedback voltage generation circuit is input to the second terminal of the error amplifier 24 and the second terminal of the gain adjustment amplifier 21.

It should be noted that the error amplifier 24 with sufficiently large gain and phase margins amplifies the deviation between the voltage V₁ which is input to the first terminal thereof from the first reference voltage circuit 20 and the feedback voltage V₂ which is input to the second terminal thereof and outputs the amplified deviation as an electric current deviation.

Meanwhile, in the gain adjustment circuit 25 that is disposed in parallel with the error amplifier 24, the gain adjustment amplifier 21 which has gain characteristics higher than those of the error amplifier 24 in a high frequency range amplifies the deviation between the voltage V₁ and the feedback voltage V₂ and outputs the amplified deviation as a voltage deviation. The voltage output from the gain adjustment amplifier 21 only in a high frequency range is allowed to pass by the high-pass filter (HPF) 22 and is supplied to the voltage-current (V/I) conversion circuit 23. Then, the voltage-current (V/I) conversion circuit 23 converts the output voltage of the high pass filter (HPF) 22 to an electric current to output an electric current. It should be noted that because the output terminal of the voltage-current (V/I) conversion circuit 23 is connected to the output terminal of the error amplifier 24, the output electric current of the error amplifier 24 and the output electric current of the voltage-current (V/I) conversion circuit 23 are added and voltage V₃ which is charged to the phase compensation capacitor 26 by the added electric current is supplied to the PWM comparator 28.

As described above, because of the large gain and phase margins, a power supply circuit with only the error amplifier 24 would have a comparably low gain in a high frequency range. Meanwhile, in addition to the error amplifier 24, the power supply circuit 10 is also provided with the gain adjustment circuit 25 which is disposed in parallel with the error amplifier 24. The gain adjustment circuit 25 has high gain characteristics in a high frequency range. In this way, the low gain characteristics of the error amplifier 24 in a high frequency range can be compensated by the gain adjustment circuit 25 which has high gain characteristics in a high frequency range.

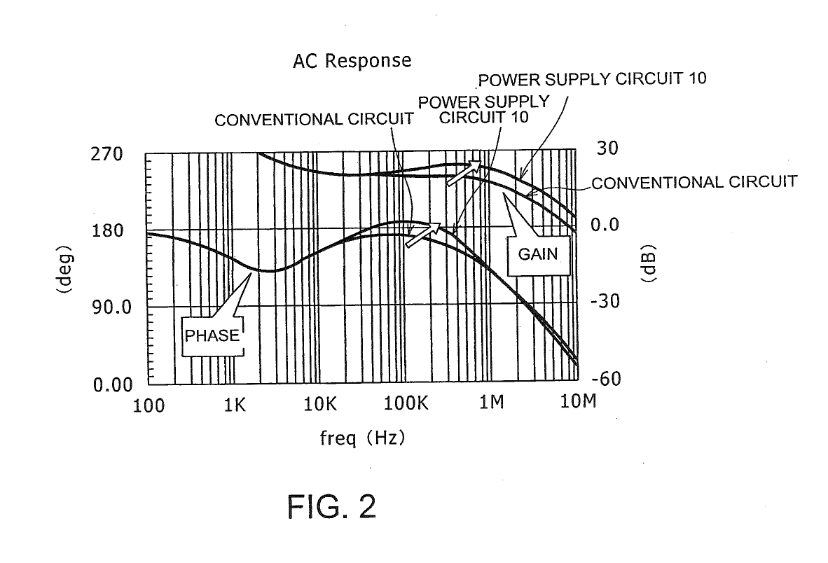

FIG. 2 shows a simulation result of a comparison between the power supply circuit 10 and a conventional circuit (equivalent to the power supply circuit 10 without the gain adjustment circuit 25) regarding gain and phase characteristics from V₂ to V₃ in FIG. 1. As shown in FIG. 2, in low frequency range (1 kHz to 10 kHz), there are no difference between the power supply circuit 10 and the conventional circuit regarding both the gain and phase characteristics, but in high frequency range (100 kHz to 1 MHz), the power supply circuit 10 has higher characteristics in both gain and phase characteristics than the conventional circuit. It should be noted that in the gain adjustment circuit 25 of the power supply circuit 10, because low frequency components of the gain adjustment amplifier 21 are blocked by the high-pass filter (HPF) 22, only high frequency components are allowed to pass. Further, because the output of the high-pass filter (HPF) 22 is added to the output current of the error amplifier 24 via the voltage-current (V/I) conversion circuit 23, it becomes possible to improve the gain and phase characteristics in the high frequency range without affecting the gain and phase characteristics in the low frequency range.

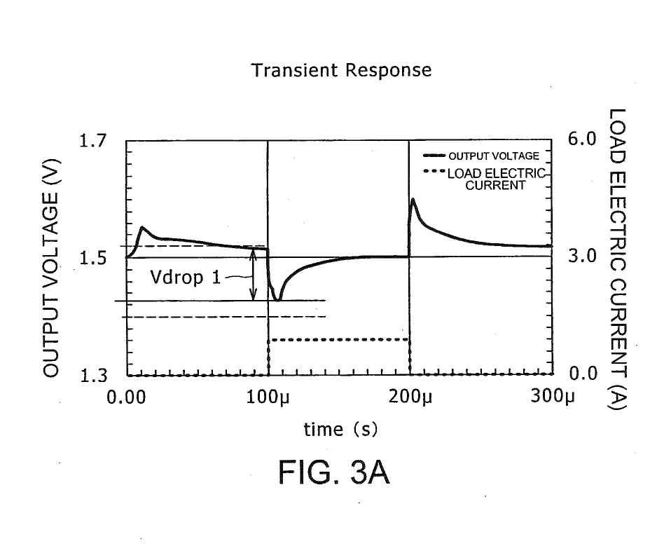

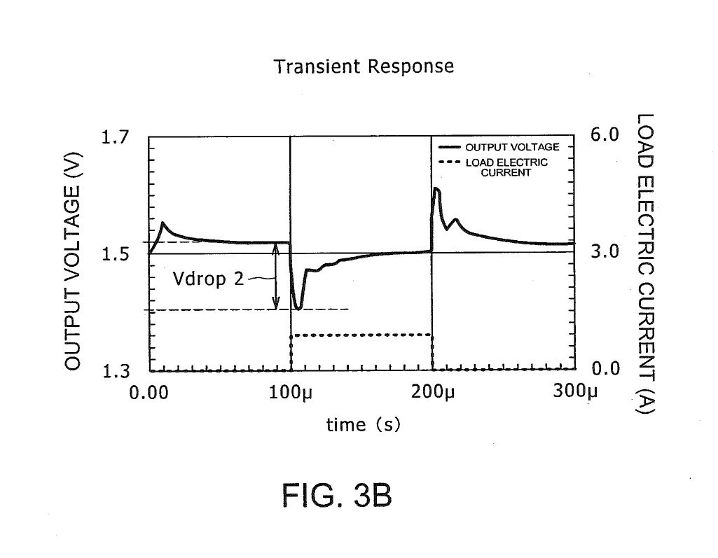

FIG. 3A shows a simulation result to check transient response characteristics of the power supply circuit 10. FIG. 3B shows a simulation result to check transient response characteristics of a conventional circuit (equivalent to the power supply circuit 10 without the gain adjustment circuit 25) to be compared with the transient response characteristics of the power supply circuit 10. In each drawing, a solid line indicates output voltage while a dashed line indicates a load electric current. It should be noted that in comparison between the power supply circuit 10 and the conventional circuit regarding the transient response characteristics, a significant difference can be observed at a voltage drop; that is, Vdrop1<Vdrop 2, as shown in FIGS. 3A and 3B. In other words, the power supply circuit 10 has transient response characteristics which are significantly improved from those of the conventional circuit by using the gain adjustment circuit 25.

What is claimed is:

1. A power supply circuit comprising:
a first error amplifier that compares a predetermined reference voltage and an output voltage of a feedback voltage generation circuit, and amplifies an obtained error to input the amplified error to the feedback voltage generation circuit; and
a gain adjustment path that is disposed in parallel with the first error amplifier and adjusts a gain of an output of the first error amplifier in a high frequency range.

2. The power supply circuit according to claim 1, wherein the gain adjustment path comprises:
a second error amplifier that compares a predetermined reference voltage and an output voltage of the feedback voltage generation circuit and amplifies an obtained error; and
a high-pass filter that passes, among outputs of the second error amplifier, components in a high frequency range and adds the passed components to the output of the first error amplifier,
wherein the second error amplifier has a gain higher than that of the first error amplifier in a high frequency range.

3. An electronic device comprising the power supply circuit according to claim 1.

4. An electronic device comprising the power supply circuit according to claim 2.
